(19) United States
(12) Patent Application Publication
(10) Pub. No.: US 2026/0188855 A1
(43) Pub. Date: Jul. 2, 2026

(54) BATTERY MODULE

(71) Applicant: TOYOTA JIDOSHA KABUSHIKI KAISHA, Toyota-shi (JP)

(72) Inventor: Takuichi ARAI, Toyota-shi (JP)

(73) Assignee: TOYOTA JIDOSHA KABUSHIKI KAISHA, Toyota-shi (JP)

(21) Appl. No.: 19/323,162

(22) Filed: Sep. 9, 2025

(30) Foreign Application Priority Data
Dec. 26, 2024 (JP) 2024-231120

(51) Int. Cl. H01M 50/517; H01M 50/503

(52) U.S. Cl. CPC H01M 50/517; H01M 50/503

(57) ABSTRACT

A battery module includes three or more battery cells, each battery cell including a positive terminal and a negative terminal, and a plurality of busbars that is electroconductive and that also connects the positive terminal of one of two of the battery cells that are adjacent to each other, to the negative terminal of the other of the two of the battery cells that are adjacent to each other, in which each of the busbars is provided with a fastening portion for mechanically fastening a bypass member that is a member different from the busbar and that is also electroconductive.

### CROSS-REFERENCE TO RELATED APPLICATION

This application claims priority to Japanese Patent Application No. 2024-231120 filed on Dec. 26, 2024. The disclosure of the above-identified application, including the specification, drawings, and claims, is incorporated by reference herein in its entirety.

### BACKGROUND

### 1. Technical Field

The present disclosure relates to a battery module.

### 2. Description of Related Art

Japanese Unexamined Patent Application Publication No. 2023-91534 (JP 2023-91534 A) discloses a battery module including a plurality of battery cells. All of the battery cells included in the battery module are electrically connected to adjacent battery cells by busbars.

### SUMMARY

In the battery module of the above JP 2023-91534 A, for example, when an abnormality occurs in one battery cell, power can no longer be extracted from the battery module. Removing the busbar from the one battery cell in which the abnormality has occurred, and connecting a new battery cell to the same busbar, enables power to be extracted from the battery module. However, such a task is not easy.

The present disclosure has been made in light of the above circumstances, and an object thereof is to provide a battery module that can output power when an abnormality occurs in one of the battery cells, without having to replace the abnormal battery cell.

A battery module according to a first aspect includes three or more battery cells, each battery cell including a positive terminal and a negative terminal, and a plurality of busbars that is electroconductive and that also connects the positive terminal of one of two of the battery cells that are adjacent to each other, to the negative terminal of the other of the two of the battery cells that are adjacent to each other, in which each of the busbars is provided with a fastening portion for mechanically fastening a bypass member that is a member different from the busbar and that is also electroconductive.

In the battery module of the first aspect, the positive terminal of one of the two battery cells that are adjacent to each other, and the negative terminal of the other thereof, are connected by the busbar. When an abnormality occurs in one battery cell that is connected to adjacent battery cells that are two battery cells, located on either side, by two busbars, the bypass member that is electroconductive is mechanically fastened to the fastening portions of the two busbars that are respectively connected to the two adjacent battery cells. This allows electricity to flow between the two adjacent battery cells while bypassing the battery cell in which the abnormality has occurred, and accordingly the battery module can output power. Thus, in a case in which an abnormality occurs in one of the battery cells, the battery module according to the first aspect can output power without replacing the abnormal battery cell.

With a second aspect of the battery module, in the first aspect, the fastening portion includes a nut that is fixed to the busbar, and a through hole that is opened in the bypass member and through which a bolt, that is configured to be screwed into the nut, is passable.

In the battery module of the second aspect, the bypass member can be easily fastened to the fastening portions of the busbars using the bolts.

With a third aspect of the battery module, in the first aspect or the second aspect, the fastening portion is spaced apart from a straight line between a connection portion of the busbar to the positive terminal and a connection portion of the busbar to the negative terminal, in plan view.

In the battery module of the third aspect, the fastening portion does not readily affect electrical resistance of the portion of the busbar through which electricity flows.

A fourth aspect of the battery module, in any one of the first aspect to the third aspect, further includes a cover member that is attachable to the busbar so as to cover the fastening portion, and that is detachable from the busbar.

In the battery module of the fourth aspect, when the bypass member is not fastened to the fastening portion, the fastening portion is covered by the cover member. Therefore, dust and moisture less readily adhere to the fastening portion.

With a fifth aspect of the battery module, in any one of the first aspect to the fourth aspect, the busbar includes a connecting protruding portion that protrudes upward.

In the battery module of the fifth aspect, for example, a connection device that is provided at an end portion of a discharge cable can be easily connected to the connecting protruding portion of the busbar.

As described above, the battery module according to the present disclosure has an excellent effect of being able to output power when an abnormality occurs in one of the battery cells, without having to replace the abnormal battery cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a plurality of battery cells, busbars, and a bypass member, that are included in a battery module according to an embodiment;

FIG. 2 is a schematic plan view of end portions and busbars of two adjacent battery cells;

FIG. 3 is a schematic perspective view of a busbar, bolts, and a connector; and

FIG. 4 is a plan view of a modification, similar to FIG. 2.

### DETAILED DESCRIPTION OF EMBODIMENTS

A battery module according to an embodiment will be described below with reference to the accompanying drawings. Note that arrow UP, arrow FR, and arrow LH in each drawing indicate an upper side in an up-down direction of a vehicle, a front side in a front-rear direction of the vehicle, and a left side in a right-left direction of the vehicle, respectively.

A battery module 10 according to the present embodiment is installed in the vehicle (electrified vehicle). The vehicle according to the present embodiment is a battery electric vehicle.

The battery module 10 according to the present embodiment includes a battery case (omitted from illustration) that is supported by a vehicle body, and a battery stack 15 that is housed inside the battery case. The battery case includes a lower case and an upper case. The battery stack 15 is provided inside the lower case, and is further fixed to a bottom plate of the lower case. When a lower edge portion of the upper case is connected to an upper edge portion of the lower case that is housing the battery stack 15 in this manner, and also the lower case and upper case are fixed together, the battery module 10 (battery stack 15) is covered by the battery case.

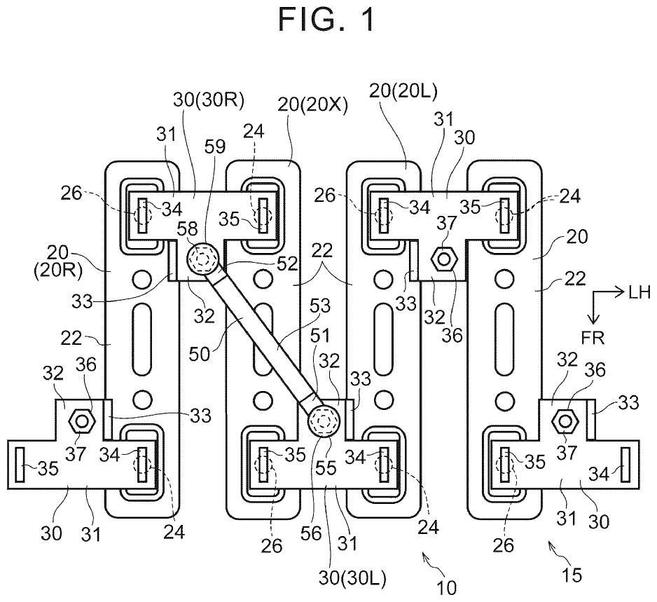

The battery module 10 includes the battery stack 15 that is illustrated in FIG. 1, a plurality of busbars 30, and a bypass member 50.

The battery stack 15 includes a great number of battery cells 20, which are secondary batteries arrayed in the right-left direction, a plurality of spacers (omitted from illustration) that is made of resin, provided between the battery cells 20 that are adjacent to each other, and to the left side of the battery cell 20 that is located on the leftmost side and to the right side of the battery cell 20 that is located on the rightmost side, a pair of end plates (omitted from illustration) that is located to the left side of the spacer that is located on the leftmost side and to the right side of the spacer that is located on the rightmost side, and restraining members (omitted from illustration) that are connected to the end plates and that also draw both end plates in a direction so as to be closer to each other. Note that while only four battery cells 20 are illustrated in FIG. 1, the actual battery stack 15 includes several dozen battery cells 20.

A cell case 22, made of metal, which makes up an outer shape of the battery cell 20 that is a lithium-ion battery, has a substantially rectangular cuboid shape. As illustrated in FIG. 1, a planar shape of the cell case 22 is a rectangle of which a front-rear dimension is greater than a right-left dimension. A positive terminal 24 and a negative terminal 26, which are external electrodes, are provided on an upper face of each cell case 22. As illustrated in FIG. 1, the battery cells 20 are arrayed in the right-left direction such that the positive terminals 24 and the negative terminals 26 are arranged alternately in the right-left direction.

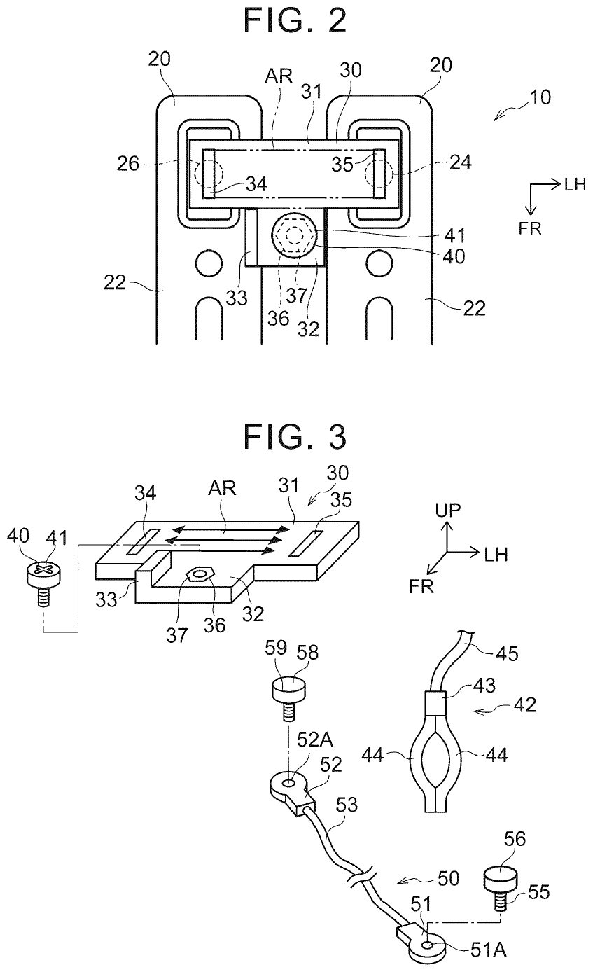

The busbars 30 are substantially flat plate members that are made of an electroconductive material such as metal or the like. Each of the busbars 30 has a general letter-T planar shape. That is to say, the busbar 30 has a conductive portion 31 that is substantially rectangular in plan view and extends linearly in one direction, a protruding portion 32 that protrudes from an edge portion of the conductive portion 31 at a middle portion in a longitudinal direction thereof, and a plate portion (connecting protruding portion) 33 that protrudes upward from an end portion of an upper face of the protruding portion 32. A first connection portion (connection portion) 34 and a second connection portion (connection portion) 35 are provided near both ends of the conductive portion 31. The upper face of the protruding portion 32 is formed with a recessed portion 36 that has a hexagonal shape in plan view. Further, a nut (fastening portion) 37 made of an electroconductive material such as metal is provided in the recessed portion 36, and the nut 37 is fixed to the protruding portion 32. As illustrated in FIG. 2, the nut 37 (protruding portion 32 and plate portion 33) is spaced apart from a strip-like region AR (straight line) that linearly connects the first connection portion 34 and the second connection portion 35 in plan view.

As illustrated in FIG. 1, each of the busbars 30 connects the positive terminal 24 and the negative terminal 26 of two battery cells 20 that are adjacent to each other in the right-left direction. That is to say, for example, the first connection portion 34 of the busbar 30 is electrically connected by welding or the like to the negative terminal 26 of the battery cell 20 that is located at the rightmost position in FIG. 1, and the second connection portion 35 of the busbar 30 is electrically connected by welding or the like to the positive terminal 24 of the second battery cell 20 from the right. That is to say, the busbar 30 is fixed to the positive terminal 24 and the negative terminal 26. Also, the second connection portion 35 of the busbar 30 is electrically connected by welding or the like to the negative terminal 26 of the second battery cell 20 from the right in FIG. 1, and the first connection portion 34 of the busbar 30 is electrically connected by welding or the like to the positive terminal 24 of the third battery cell 20 from the right. In the present embodiment, the battery cells 20 are connected in a serial state by a great number of busbars 30.

A cover bolt (cover member) 40 that is illustrated in FIG. 3 can be screwed onto the nut 37 of the busbar 30. A head 41 of the cover bolt 40 has a larger diameter than the nut 37. Accordingly, when the cover bolt 40 is screwed into the nut 37 and the head 41 is brought into contact with an upper face of the nut 37 and an upper face of the plate portion 33, the entire nut 37 is covered by the head 41 (see FIG. 2).

### Operations and Effects

Next, the operation and effects of the embodiment will be described.

When all of the battery cells 20 that make up the battery stack 15 are operating normally, for example, power of the battery module 10 is supplied to various types of devices or equipment installed in the vehicle via an electrical connector (omitted from illustration) that is electrically connected to the battery module 10 and a harness or the like (omitted from illustration) that is connected to the electrical connector. For example, the power of the battery module 10 (battery cells 20) is supplied to an electric motor (omitted from illustration) that imparts rotational driving force to drive wheels.

When an abnormality, such as internal short-circuiting or the like, occurs in any of the battery cells 20 of the battery module 10, for example, flow of electricity in the battery stack 15 may be interrupted by this battery cell 20 (hereinafter referred to as “abnormal battery cell 20X”). Now, an assumption will be made that, for example, a battery cell 20 that is denoted by reference numeral 20X in FIG. 1 is the abnormal battery cell 20X. In this case, the power of the battery module 10 will not be supplied to the above-mentioned devices and equipment. Accordingly, in this case, the lower case of the battery case is separated from the upper case to expose the battery stack 15. Further, the cover bolt 40 is removed from the nut 37 of the busbar 30 (hereinafter referred to as “right busbar 30R”) that connects the abnormal battery cell 20X to the battery cell 20 that is adjacent to the abnormal battery cell 20X to the right (right-side battery cell 20R), and also the cover bolt 40 is removed from the nut 37 of the busbar 30 (hereinafter referred to as “left busbar 30L”) that connects the abnormal battery cell 20X to the battery cell 20 that is adjacent to the abnormal battery cell 20X to the left (left-side battery cell 20L).

Next, a connector 42 (see FIG. 3) that is provided at an end portion of a harness 45 that is connected to a discharger (omitted from illustration) is connected to the plate portion 33 of the left busbar 30L and the plate portion 33 of the right busbar 30R. The connector 42 includes a main body 43 and a pair of rotational connection portions 44 that is rotatable relative to the main body 43, and each of the rotational connection portions 44 is biased to rotate in a direction drawing near to each other by the biasing force of a spring (omitted from illustration). Therefore, the plate portion 33 can be clamped between the rotational connection portions 44. That is to say, the connector 42 can be easily connected to the plate portion 33. The rotational connection portions 44 are made of an electroconductive material, and are connected to the harness 45 that is connected to the discharger. Accordingly, after a predetermined time has elapsed in a state in which the connectors 42 are each connected to the plate portion 33 of the left busbar 30L and the plate portion 33 of the right busbar 30R, the power of the abnormal battery cell 20X is discharged to the discharger, and voltage of the abnormal battery cell 20X becomes equal to or lower than a predetermined value (e.g., 1 volt).

When the voltage of the abnormal battery cell 20X falls to the predetermined value or lower, the connectors 42 are removed from the plate portions 33, and also the electrical connector is removed from the battery module 10. Next, the bypass member 50 that is illustrated in FIGS. 1 and 3 is connected to the plate portion 33 of the left busbar 30L and the plate portion 33 of the right busbar 30R. The bypass member 50 has a first connection portion 51 and a second connection portion 52 that are made of an electroconductive material such as metal or the like, and a harness 53 that is made of an electroconductive material such as a metal or the like that is flexible and connects the first connection portion 51 and the second connection portion 52. Further, the first connection portion 51 has a first through hole (through hole) 51A formed therein, and the second connection portion 52 has a second through hole (through hole) 52A formed therein. As illustrated in FIG. 1, the first connection portion 51 and the second connection portion 52 of the bypass member 50 are placed on an upper face of the protruding portion 32 of the left busbar 30L and an upper face of the protruding portion 32 of the right busbar 30R, respectively. Further, a bolt 55 that is inserted from above into the first through hole 51A is screwed into the nut 37 of the protruding portion 32 of the left busbar 30L, and also a head 56 of the bolt 55 is pressed against an upper face of the first connection portion 51, and a bolt 58 inserted from above into the second through hole 52A is screwed into the nut 37 of the protruding portion 32 of the right busbar 30R, and also a head 59 of bolt 58 is pressed against an upper face of the second connection portion 52. Further, the electrical connector is reconnected to the battery module 10. Thus, the left busbar 30L and the right busbar 30R are electrically connected by the bypass member 50 and the nuts 37, and power from the battery module 10 is once again supplied to the device or the equipment via the electrical connector, the harness, or the like. Thus, when an abnormality occurs in an abnormal battery cell 20X, which is part of the battery cells 20, the battery module 10 is able to output power without replacing the abnormal battery cell 20X with a new battery cell. Further, there is no need to replace the entire battery module 10 with a new battery module.

Further, when the busbar 30 connects the positive terminal 24 and the negative terminal 26 of two adjacent battery cells 20, electricity flows over the strip-like region AR of the busbar 30 (see arrows in FIG. 3). As described above, the nut 37 (recessed portion 36), the protruding portion 32, and the plate portion 33 are spaced apart from the strip-like region AR that linearly connects the first connection portion 34 and the second connection portion 35 of the busbar 30 in plan view. Accordingly, the nut 37, the protruding portion 32, and the plate portion 33 do not readily affect electrical resistance of the strip-like region AR. Thus, there is little risk that the amount of heat that is generated by the busbar 30 will become extremely great due to the nut 37, the protruding portion 32, and the plate portion 33, or that mechanical strength of the busbar 30 will decrease due to heat that is generated.

Further, when the bypass member 50 is not mechanically fastened to the nut 37 of the busbar 30, the nut 37 is covered by the head 41 of the cover bolt 40. Accordingly, when the bypass member 50 is not fastened to the nut 37 of the busbar 30, dust and moisture are less likely to adhere to the nut 37.

Although the battery module according to the embodiment has been described above, the design thereof can be appropriately modified without departing from the scope of the present disclosure.

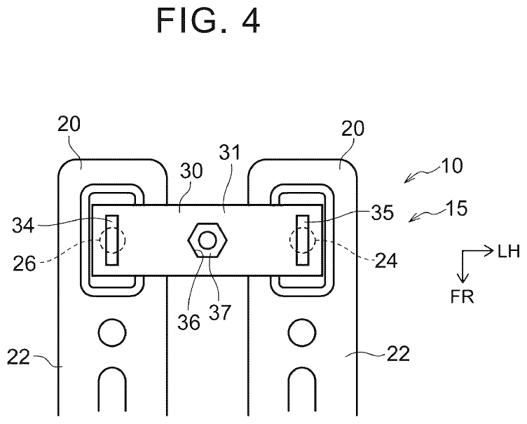

For example, as illustrated in FIG. 4, an arrangement may be made in which the busbar 30 does not include the protruding portion 32 and the plate portion 33, and the nut 37 (recessed portion 36) is provided in the middle portion of the busbar 30 (conductive portion 31) in the longitudinal direction.

Regardless of whether the busbar 30 has the protruding portion 32 and the plate portion 33, the fastening portion that is a structure for mechanically fastening the busbar 30 to the bypass member 50 may be different from the nut 37. For example, the fastening portion of the busbar 30 may be a through hole that passes through the busbar 30 in the up-down direction. In this case, for example, bolts that pass downward through the first through hole 51A and the second through hole 52A of the bypass member 50 pass downward through holes of the busbar 30, and nuts are screwed onto external thread grooves of the bolts below the busbar 30, whereby the nuts are pressed against a lower face of the busbar 30, and also heads of the bolts are pressed against an upper face of the busbar 30. In addition, for example, pin-like members that are made of an electroconductive material, such as metal or the like, that pass downward through the first through hole 51A and the second through hole 52A of the bypass member 50 may pass downward through the through holes of the busbars 30, and these pin-shaped members may be crimped with respect to the busbars 30 and the bypass member 50, while being plastically deformed.

The fastening portions of the busbars 30 may also be electrical connectors. For example, when the fastening portions of the busbars 30 are male connectors, female connectors are provided at both end portions of the harness 53 of the bypass member 50, and the female connectors are connected to the male connectors of the busbars 30, respectively. Note that in this case, the male connectors and the female connectors may be fixed to each other by fixing means such as welding or the like.

The nut 37 may be covered by a plug cap instead of by the cover bolt 40.

In a case in which the fastening portion, which is a structure for mechanically fastening the bypass member 50 to the busbar 30, is a through hole, a plug member that is pressed into the through hole or tape adhered to both the upper and lower faces of the protruding portion 32 so as to cover end faces of the through hole may be used instead of the cover bolt 40.

The busbar 30 may include a pin (connecting protruding portion) instead of the plate portion 33.

The number of the battery cells 20 included in the battery stack 15 may be any number as long as three or more.

The vehicle may be an electrified vehicle that is different from a battery electric vehicle, and that also has an electric motor that utilizes the power of the battery module 10. For example, the vehicle may be a hybrid electric vehicle or a plug-in hybrid electric vehicle.

What is claimed is:

1. A battery module comprising:
three or more battery cells, each battery cell including a positive terminal and a negative terminal; and
a plurality of busbars that is electroconductive and that also connects the positive terminal of one of two of the battery cells that are adjacent to each other, to the negative terminal of the other of the two of the battery cells that are adjacent to each other, wherein
each of the busbars is provided with a fastening portion for mechanically fastening a bypass member that is a member different from the busbar and that is also electroconductive.

2. The battery module according to claim 1, wherein
the fastening portion includes
a nut that is fixed to the busbar, and
a through hole that is opened in the bypass member and through which a bolt, that is configured to be screwed into the nut, is passable.

3. The battery module according to claim 1, wherein the fastening portion is spaced apart from a straight line between a connection portion of the busbar to the positive terminal and a connection portion of the busbar to the negative terminal, in plan view.

4. The battery module according to claim 1, further comprising a cover member that is attachable to the busbar so as to cover the fastening portion, and that is detachable from the busbar.

5. The battery module according to claim 1, wherein the busbar includes a connecting protruding portion that protrudes upward.
